(19) United States
(12) Patent Application Publication
(10) Pub. No.: US 2007/0180402 A1
(43) Pub. Date: Aug. 2, 2007

(54) Method for managing dynamic chat objects

(76) Inventors: Richard Bassemir, Austin, TX (US); Samuel R. Detweiler, Cedar Park, TX (US); Randolph M. Forlenza, Austin, TX (US); John P. Kaemmerer, Pflugerville, TX (US)

Correspondence Address: IBM CORP. (CLG);c/o CARDINAL LAW GROUP, 1603 ORRINGTON AVENUE, SUITE 2000, EVANSTON, IL, 60201, US

(21) Appl. No.: 11/345,924

(22) Filed: Feb. 2, 2006

(51) Int. Cl. G06F 3/00

(52) U.S. Cl. 715/798; 715/753; 715/769

(57) ABSTRACT

A method of managing chat objects includes receiving dropped chat object and dragged chat object commands associated with chat objects at a chat management system and determining space availability of the chat management system. The method further includes determining at least one spatial characteristic of at least one chat management system object, and adjusting at least one object display characteristic of the chat management system object based on the determined space availability and determined chat management system object spatial characteristic. A computer usable medium including computer readable code and a system for managing chat objects is also disclosed.

### FIELD OF INVENTION

The present invention generally relates to managing dynamic objects. More specifically, the invention relates to managing chat objects by inserting and removing them from chat application management systems.

### BACKGROUND OF THE INVENTION

Many people communicate using chat or instant messaging applications. These applications enable individuals to communicate privately or publicly with other individuals with minimal communication latency regardless of the location of each individual. Each chat window is a dynamic object, and subject to real time changes.

However, users of these technologies often encounter difficulties managing these communications as the number of simultaneous chat communications increases. Each dynamic window receives and sends communications in substantial real time (i.e. with minimal latency). As additional chat sessions are created, the user's screen becomes more cluttered and difficult to manage.

It is therefore a challenge to develop a method to manage dynamic chat objects to overcome these, and other, disadvantages.

### SUMMARY OF THE INVENTION

A method of managing chat objects includes receiving a chat object command associated with a chat object that has been dragged-and-dropped into a chat management system and subsequently determining space availability within the chat management system. The method further includes determining at least one spatial characteristic of at least one dropped chat management system object, and adjusting at least one object display characteristic of the dropped chat management system object based on the determined space availability and determined chat management system object spatial characteristic

A computer usable medium including computer readable code for managing chat objects includes computer readable code for receiving a dropped chat object command associated with a chat object at a chat management system and computer readable code for determining space availability of the chat management system. The medium further includes computer readable code for determining at least one spatial characteristic of at least one chat object dropped into a chat management system, and computer readable code for adjusting at least one object display characteristic of the chat management system object based on the determined space availability and determined dropped chat management system object spatial characteristic.

A system for managing chat objects includes means for receiving a dropped chat object command associated with a chat object at a chat management system and means for determining space availability of the chat management system. The system further includes means for determining at least one spatial characteristic of at least one chat management system object, and means for adjusting at least one object display characteristic of the chat management system object based on the determined space availability and determined chat management system object spatial characteristic.

The foregoing embodiment and other embodiments, objects, and aspects as well as features and advantages of the present invention will become further apparent from the following detailed description of various embodiments of the present invention. The detailed description and drawings are merely illustrative of the present invention, rather than limiting the scope of the present invention being defined by the appended claims and equivalents thereof

### BRIEF DESCRIPTION OF THE DRAWINGS

FIG. 1 illustrates one embodiment of a computer client, in accordance with one aspect of the invention;

FIG. 2 illustrates a system for managing chat objects, in accordance with one aspect of the invention;

FIG. 3 illustrates an embodiment of a method for managing chat objects, in accordance with one aspect of the invention;

FIG. 4 illustrates an embodiment of a method for removing chat objects, in accordance with one aspect of the invention;

FIG. 5 illustrates another embodiment of a method for placing chat objects on a chat management system, in accordance with one aspect of the invention; and

FIG. 6 illustrates an embodiment of a method for maintaining spatial characteristics of a primary chat management system object, in accordance with one aspect of the invention.

### DETAILED DESCRIPTION OF THE PRESENT INVENTION

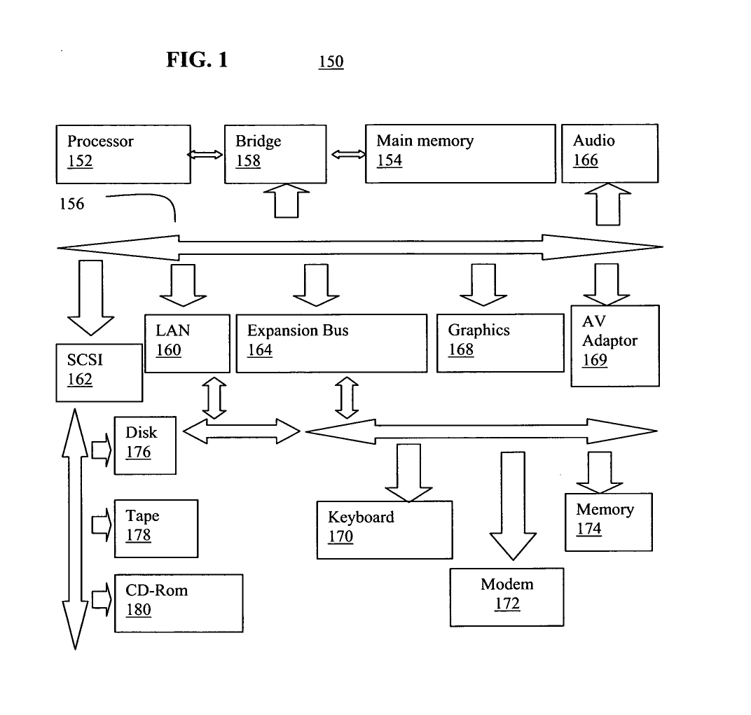

FIG. 1 illustrates one embodiment of a computer client 150 for use in accordance with one aspect of the invention. Computer system 150 is an example of a client computer. Computer system 150 employs a peripheral component interconnect (PCI) local bus architecture. Although the depicted example employs a PCI bus, other bus architectures such as Micro Channel and ISA may be used. PCI bridge 158 connects processor 152 and main memory 154 to PCI local bus 156. PCI bridge 158 also may include an integrated memory controller and cache memory for processor 152. Additional connections to PCI local bus 156 may be made through direct component interconnection or through add-in boards. In the depicted example, local area network (LAN) adapter 160, SCSI host bus adapter 162, and expansion bus interface 164 are connected to PCI local bus 156 by direct component connection. In contrast, audio adapter 166, graphics adapter 168, and audio/video adapter (A/V) 169 are connected to PCI local bus 156 by add-in boards inserted into expansion slots. Expansion bus interface 164 connects a keyboard and mouse adapter 170, modem 172, and additional memory 174 to bus 156. SCSI host bus adapter 162 provides a connection for hard disk drive 176, tape drive 178, and CD-ROM 180 in the depicted example. In one embodiment, the PCI local bus implementation support three or four PCI expansion slots or add-in connectors, although any number of PCI expansion slots or add-in connectors can be used to practice the invention.

An operating system runs on processor 152 to coordinate and provide control of various components within computer system 150. The operating system may be any appropriate available operating system such as Windows, Macintosh, UNIX, LINUX, or OS/2, which is available from International Business Machines Corporation. “OS/2” is a trademark of International Business Machines Corporation. Instructions for the operating system, an object-oriented operating system, and applications or programs are located on storage devices, such as hard disk drive 176 and may be loaded into main memory 154 for execution by processor 152.

Those of ordinary skill in the art will appreciate that the hardware in FIG. 1 may vary depending on the implementation. For example, other peripheral devices, such as optical disk drives and the like may be used in addition to or in place of the hardware depicted in FIG. 1. FIG. 1 does not illustrate any architectural limitations with respect to the present invention, and rather merely discloses an exemplary system that could be used to practice the invention. For example, the processes of the present invention may be applied to multiprocessor data processing system.

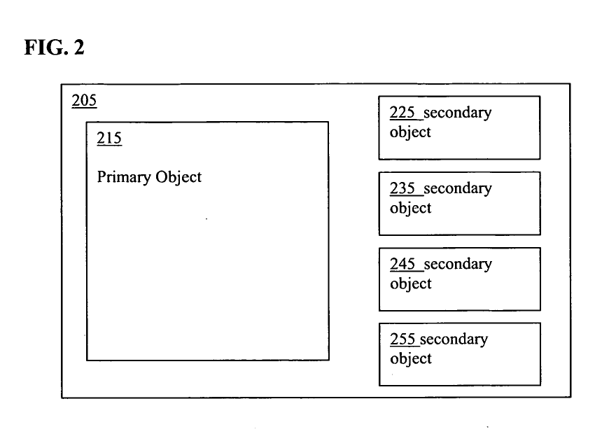

FIG. 2 illustrates one example of a primary chat management system object 215 and secondary chat management system objects 225, 235, 245, and 255 displayed on chat management system 205 at 200. In the embodiment illustrated in FIG. 2, each secondary chat management system object 225, 235, 245, and 255 is substantially the same size, although this is not a limitation of the invention, and each secondary chat management system object need not be similarly sized. In one embodiment, the adjustment includes adjustments to the graphical look and feel of the chat management system object. In another embodiment, the graphical look and feel of the chat management system objects remains unchanged based on any adjustments to the spatial characteristics.

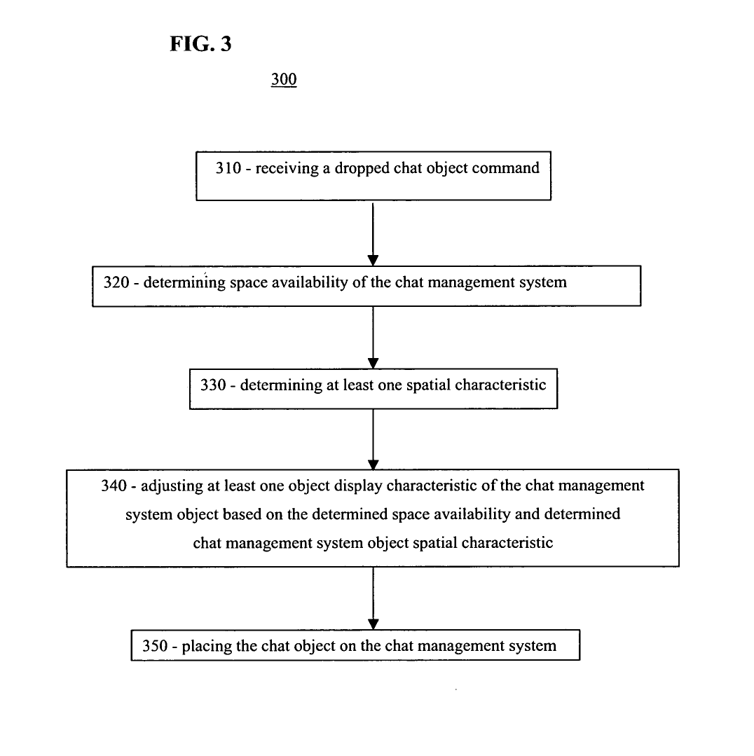

FIG. 3 illustrates one embodiment of a method for managing chat objects, in accordance with one aspect of the invention. Method 300 begins at 310, wherein a chat management system application receives a dropped chat object command associated with a dropped chat object. In one embodiment, a chat management system includes a dashboard application. A dropped chat object command is a command indicative of a user dragging-and-dropping a chat object from a first location not within control of the application to a second location within control of the application. A chat object is a dynamic window object configured for real time sending and receiving of information or communications. An exemplary chat object is an instant messaging window. Another exemplary chat object is a chat window. The application can be any appropriate program configured for execution on a computer platform. In one embodiment, the chat management system application incorporates a chat management system function. For example, the chat object can be a window executing instant messaging programs such as AOL Instant Messager, NotesBuddy, Yahoo! IM, or the like.

The application determines space availability of the chat management system at step 320. The space availability is the area defined by the borders of the application window. In one embodiment, determining space availability includes determining unoccupied space and occupied space. In another embodiment, the determination includes a determination of a proportion of occupied space to total space availability. The determination includes, in one embodiment, a determination of at least one chat management system object. A chat management system object is an object displayed by the chat management system and/or controlled by the chat management system.

The application determines at least one spatial characteristic of at least one chat management system object at step 330. A spatial characteristic is data indicative of the footprint or other physical representation of a chat management system object. For example, a chat management system object can include a vertical dimension and horizontal dimension as spatial characteristics.

In order to absorb a dropped chat object, the application adjusts at least one object display characteristic of at least one chat management system object based on the determined space availability and determined chat management system object spatial characteristics at step 340. For example, the vertical and horizontal dimensions of objects contained within the chat management system are adjusted by shortening each dimension. Alternatively, only a single dimension or characteristic is adjusted based on the spatial characteristics. In another example, the position of the chat management system object is adjusted, either with or without adjusting the dimensional characteristics. In one embodiment, the size of at least one secondary chat management system object is proportionally adjusted to accommodate a spatial characteristic of an additional dropped chat object based on receiving the designation of the primary chat management system object. A primary chat management system object is a chat management system object that is segregated from the remaining, secondary, chat management system objects and is the active object currently receiving and sending inputs and outputs.

The application places the dragged chat object on the chat management system at step 350. The dragged chat object is positioned on the chat management system based on the spatial characteristics of the chat management system and the number of other chat management system objects. Once the chat object is placed on the chat management system, the dragged chat object is further grouped with at least one other chat management system object, in one embodiment In another embodiment, objects on the chat management system, including the chat object and chat management system objects, remain independent and ungrouped. In one embodiment, placing the chat object on the chat management system comprises making adjustments to the graphical look and feel of the chat object In another embodiment, the graphical look and feel of the chat objects remains unchanged based on placement on the chat management system.

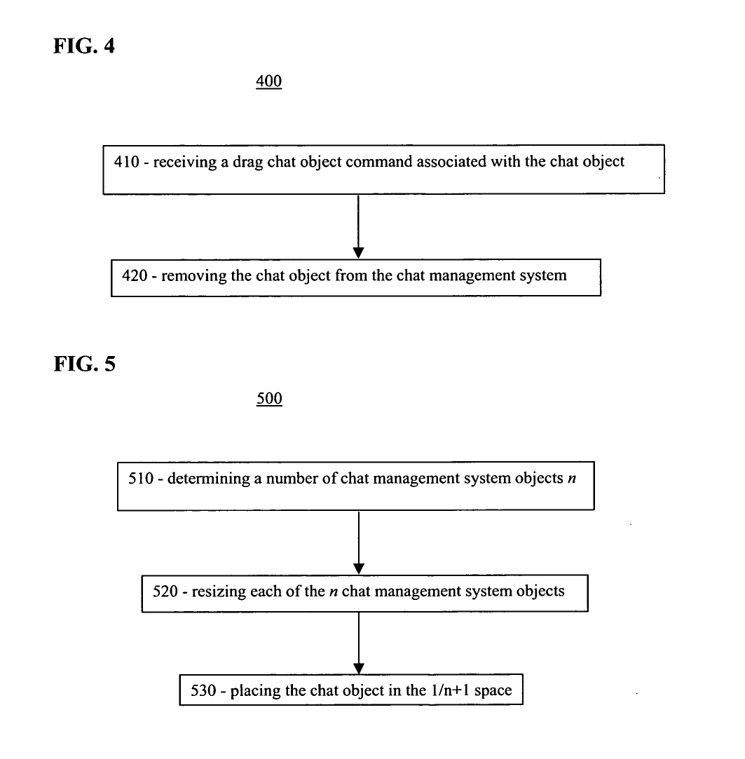

FIG. 4 illustrates one embodiment of a method 400 for removing a chat object from a chat management system in accordance with one aspect of the invention. In one embodiment, method 400 is executed after step 350 of method 300.

At step 410, a drag chat object command associated with a chat object is received at the chat management system. Based on the received drag chat object command, the chat management system releases any groupings or associations from the associated chat object.

The chat object is removed from the chat management system at step 420 based on receiving commands responsive to a user dragging-and-dropping the chat object from the chat management system to a desktop or other application not under the control of the chat management system.

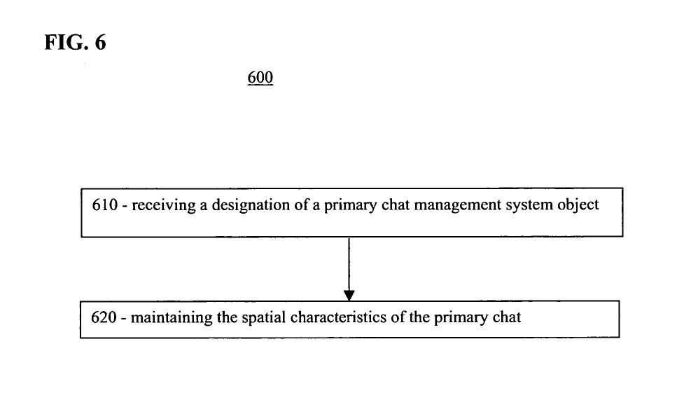

FIG. 5 illustrates one embodiment of a method 500 for placing a chat object on a chat management system in accordance with one aspect of the invention. For example, method 500 is implemented during step 350 of method 300.

The application determines a number of chat management system objects n at step 510. The spatial characteristics of each of the n chat management system objects is further determined, in one embodiment

Each of the n chat management system objects is resized to free up 1/n+1 of the chat management system space at step 520. For example, one chat management system includes 3 chat management system objects, and therefore each of the 3 chat management system objects is resized to free up ¼ of the chat management system space. In one embodiment, the proportion of each chat management system object to the total size is maintained during the resizing. In another embodiment, each chat management system object is resized to occupy 1/n+1 of the chat management system so that each chat management system object features the same vertical and horizontal dimensions.

Based on the 1/n+1 free space, the application places the chat object in the 1/n+1 space at step 530. In one embodiment, step 530 is implemented in similar fashion as step 350. The 1/n+1 space that receives the chat object can be determined as either a top or bottom space, occupying the upper portion or lower portion, respectively, of the chat management system, in one embodiment. Alternatively, the chat object is placed in a user-determined position in another embodiment. The user-determined position can be indicated by receiving a drop command responsive to a mouse click, for example.

In one embodiment, the application readjusts the visual characteristics of any chat objects remaining under control of the application after an object is removed from control of the application, such as following execution of method 400. For example, the application reverses at least one previous adjustment. In another embodiment, the application determines a number m objects remaining under control of the application, and resizes each, so that each object occupies 1/m of the available space. In another embodiment, the application does not resize the m objects, and an “empty” space remains where the removed chat object had been located prior to removal.

FIG. 6 illustrates one embodiment of a method 600 for managing chat objects in accordance with one aspect of the invention. Method 600 begins at 610 by receiving a designation of a primary chat management system object The designation of a primary chat management system object can be responsive to any command, such as a mouse click or other command generated by a command input device

Based on the designation, the chat management system maintains the spatial characteristics of the primary chat management system object, such as during step 340, regardless of any adjustments to the spatial characteristics of any secondary chat management system object at step 620. In one embodiment, the size of at least one secondary chat management system object is proportionally adjusted to accommodate a spatial characteristic of a chat object based on receiving the designation of the primary chat management system object.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc. Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device), or a propagation medium such as a carrier wave. Examples of a computer-readable medium include a semiconductor or solid state memory, magnetic tape, a removable computer diskette, a random access memory (RAM), a read-only memory (ROM), a rigid magnetic disk and an optical disk.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

We claim:

1. A method of managing chat objects, the method comprising:
receiving a dropped chat object command associated with a chat object at a chat management system;
determining space availability of the chat management system;
determining at least one spatial characteristic of at least one chat management system object, and
adjusting at least one object display characteristic of the chat management system object based on the determined space availability and determined chat management system object spatial characteristic.

2. The method of claim 1 further comprising placing the chat object on the chat management system.

3. The method of claim 2 further comprising:
receiving a drag chat object command associated with the chat object;
removing the chat object from the chat management system, wherein the chat object is dragged from the chat management system.

4. The method of claim 1 wherein adjusting the object display characteristics comprises adjusting at least one of a horizontal dimension and a vertical dimension of the chat management system object.

5. The method of claim 4 wherein the adjustment is based on a proportion of the spatial characteristic to the space availability.

6. The method of claim 1 further comprising:
determining a number of chat management system objects n;
resizing each of the n chat management system objects to free up at least 1/n+1 of the chat management system space; and
placing the chat object in the 1/n+1 space.

7. The method of claim 1 further comprising:
receiving a designation of a primary chat management system object; and
maintaining the spatial characteristics of the primary chat management system object, while adjusting the spatial characteristics of at least one other chat management system object.

8. The method of claim 1 wherein adjusting at least one object display characteristic of the chat management system object based on the determined space availability and determined chat management system object spatial characteristic comprises receiving a designation of a primary chat management system object and proportionally reducing the size of at least one other chat management system object to accommodate a spatial characteristic of the chat object.

9. A computer readable medium including computer readable code for managing chat objects, the medium comprising:
computer readable code for receiving a dropped chat object command associated with a chat object at a chat management system;
computer readable code for determining space availability of the chat management system;
computer readable code for determining at least one spatial characteristic of at least one chat management system object, and
computer readable code for adjusting at least one object display characteristic of the chat management system object based on the determined space availability and determined chat management system object spatial characteristic.

10. The medium of claim 9 further comprising:
computer readable code for placing the chat object on the chat management system.

11. The medium of claim 10 further comprising:
computer readable code for receiving a drag chat object command associated with the chat object; and
computer readable code for removing the chat object from the chat management system, wherein the chat object is dragged from the chat management system.

12. The medium of claim 9 wherein computer readable code for adjusting the object display characteristics comprises computer readable code for adjusting at least one of a horizontal dimension and a vertical dimension of the chat management system object.

13. The medium of claim 12 wherein the adjustment is based on a proportion of the spatial characteristic to the space availability.

14. The medium of claim 9 further comprising:
computer readable code for determining a number of chat management system objects n;
computer readable code for resizing each of the n chat management system objects to free up at least 1/n+1 of the chat management system space; and
computer readable code for placing the chat object in the 1/n+1 space.

15. The medium of claim 9 further comprising:
computer readable code for receiving a designation of a primary chat management system object; and
computer readable code for maintaining the spatial characteristics of the primary chat management system object, while adjusting the spatial characteristics of at least one other chat management system object.

16. The medium of claim 9 wherein computer readable code for adjusting at least one object display characteristic of the chat management system object based on the determined space availability and determined chat management system object spatial characteristic comprises computer readable code for receiving a designation of a primary chat management system object and computer readable code for proportionally reducing the size of at least one other chat management system object to accommodate a spatial characteristic of the chat object.

17. A system for managing chat objects, the system comprising:
means for receiving a dropped chat object command associated with a chat object at a chat management system;
means for determining space availability of the chat management system;
means for determining at least one spatial characteristic of at least one chat management system object, and
means for adjusting at least one object display characteristic of the chat management system object based on the determined space availability and determined chat management system object spatial characteristic.
